(19) United States
(12) Patent Application Publication
(10) Pub. No.: US 2012/0075426 A1
(43) Pub. Date: Mar. 29, 2012

(54) IMAGE PICKUP SYSTEM

(75) Inventor: Makiko Saito, Tokyo (JP)

(73) Assignee: CANON KABUSHIKI KAISHA, Tokyo (JP)

(21) Appl. No.: 13/231,521

(22) Filed: Sep. 13, 2011

(30) Foreign Application Priority Data
Sep. 28, 2010 (JP) 2010-217095

(51) Int. Cl. H04N 13/02

(52) U.S. Cl. 348/46; 348/E13.074

(57) ABSTRACT

An image pickup system capable of shortening time lag between reading of signals from an image sensor and displaying of the signals when a 3D image signal from a camera having the single image sensor is displayed in real time with a time-division system. A solid state image pickup device has pixels that are arranged in two dimensions and are divided into image pickup areas. A reading unit reads signals from the image pickup areas. A mode setting unit sets either of a first shooting mode and a second shooting mode. A control unit controls the reading unit to read signals from all the image pickup areas as a single frame when the mode setting unit sets the first shooting mode, and reads the signals from the image pickup areas as different frames, respectively, when the mode setting unit sets the second shooting mode.

### BACKGROUND OF THE INVENTION

1. Field of the Invention

The present invention relates to an image pickup system, and particularly relates to a technique to read signals from a solid state image pickup device that is suitable to shoot a three-dimensional (3D) image.

2. Description of the Related Art

As a 3D digital camera that can shoot and display a 3D image, FinePix REAL 3D W1 of Fujifilm Corporation, etc. is known, for example. As disclosed in the user's manual therefor and Japanese Laid-Open Patent Publication (Kokai) No. 2009-188931 (JP 2009-188931A), such a 3D digital camera is provided with two optical systems that have parallax, and two solid state image pickup devices (image sensors) corresponding to the optical systems, respectively, in one camera body, and shoots subject images viewed from two viewpoints.

The acquired subject images from two viewpoints are displayed on an LCD as a “left eye image” and a “right eye image” with a time-division system. The LCD alternately displays a “left eye image” and a “right eye image”, and changes light sources of a back light in synchronization with the change of the images. That is, the LCD enables a user to appreciate 3D image by emitting one light source to direct the light to a user's left eye when a “left eye image” is displayed, and by emitting the other light source to direct the light to a user's right eye when a “right eye picture” is displayed.

It should be noted that there is a displaying method with the time-division system to use special glasses of which right and left lenses have shutters that open and close alternately in synchronization with the change of the “left eye image” and the “right eye image” that are displayed alternately, as well as the above-mentioned method to change the light sources of the back light.

However, since the technique disclosed in the above-mentioned publication needs two sets of the image pickup optical systems and the solid state image pickup devices, a size of a camera becomes large. On the other hand, there is a known technique to shoot a subject image for generating a 3D image by using a single digital camera having a single image sensor. In this case, a light receiving area of the single image sensor is divided into two areas of right and left, and a “left eye image” is generated by signals from the left area and a “right eye image” is generated by signals from the right area. However, since signals from pixels on a line across the left and right areas are sequentially taken out from a solid state image pickup device (an image sensor) in general, image signals for one frame are read under the condition where the pixel signals for generating a “left eye image” and the image signals for generating a “right eye image” are mixed. Then, after the signals from all the pixels have been read, the “right eye image” and the “left eye image” that will be displayed as next images are generated.

As mentioned above, the display devices, such as a display and a projector that display a 3D movie and a 3D image with the time-division system, alternately change and display a “left eye image” and a “right eye image”. Accordingly, when the 3D image signals from the camera having the single image sensor are displayed in real time, a time lag of switching to display a next frame is large. Since not all the pixel signals for the “left eye image” are acquired until the pixel signals from the entire area (the left area and the right area) have been read, the “left eye image” cannot be generated previously even if the “left eye image” should be displayed.

### SUMMARY OF THE INVENTION

The present invention provides an image pickup system that is capable of shortening the time lag between reading of a pixel signal from an image sensor and displaying of an image signal generated from the pixel signal when a 3D image signal from a camera having the single image sensor is displayed in real time with a time-division system.

Accordingly, a first aspect of the present invention provides an image pickup system comprising a solid state image pickup device configured to have pixels that receive incident lights and generate electric charges, the pixels being arranged in two dimensions and being divided into image pickup areas, a reading unit configured to read signals from the image pickup areas of the solid state image pickup device, a mode setting unit configured to set either of a first shooting mode and a second shooting mode that is different from the first shooting mode, and a control unit configured to control the reading unit to read signals from all the image pickup areas as a single frame when the mode setting unit sets the first shooting mode, and to read the signals from the image pickup areas as different frames, respectively, when the mode setting unit sets the second shooting mode.

Accordingly, a second aspect of the present invention provides an image pickup system comprising a solid state image pickup device configured to have pixels that receive incident lights and generate electric charges, the pixels being arranged in two dimensions and being divided into image pickup areas, a reading unit configured to read signals from the image pickup areas, a display unit configured to display an image based on the signals read by the reading unit, and a control unit configured to control the reading unit to read signals from all the image pickup areas as a single frame when a display method of the display unit is a two-dimensional display, and to read the signals from the image pickup areas as different frames, respectively, when the display method of the display unit is a three-dimensional display.

Accordingly, a third aspect of the present invention provides an image pickup system comprising a solid state image pickup device configured to have pixels that receive incident lights and generate electric charges, the pixels being arranged in two dimensions and being divided into image pickup areas, a reading unit configured to read signals from the image pickup areas, a display unit configured to display an image based on the signals read by the reading unit, and a control unit configured to control the reading unit to read signals from all the image pickup areas as a single frame when a display method of the display unit is other than a time-division system, and to read the signals from the image pickup areas as different frames, respectively, when the display method of the display unit is the time-division system.

Accordingly, the present invention is capable of shortening the time lag between reading of a pixel signal from an image sensor and displaying of an image signal generated from the pixel signal when a 3D image signal from a camera having the single image sensor is displayed in real time with the time-division system.

Further features of the present invention will become apparent from the following description of exemplary embodiments with reference to the attached drawings.

### BRIEF DESCRIPTION OF THE DRAWINGS

FIG. 1 is a block diagram schematically showing an entire configuration of an image pickup system according to an embodiment of the present invention.

FIG. 2 is a view showing a configuration of an optical system with which the image pickup system in FIG. 1 is equipped.

FIG. 3 is an equivalent circuit schematic of a CMOS image sensor used as an image sensor shown in FIG. 2.

FIG. 4 is a flowchart showing an image pickup operation and a displaying operation of the image pickup system in FIG. 1.

FIG. 5 is a view showing a drive pattern used in steps S13 and S17 in FIG. 4 for reading 3D signals from the image sensor.

FIG. 6 is a view showing a drive pattern used in steps S03 and S07 in FIG. 4 for reading 2D signals from the image sensor.

FIG. 7 is an equivalent circuit schematic of a modification of the CMOS image sensor shown in FIG. 3.

### DESCRIPTION OF THE EMBODIMENTS

Hereafter, embodiments according to the present invention will be described in detail with reference to the drawings.

The present invention is applied to an image pickup apparatus that can generate an image signal that can be displayed with a time-division system based on a pixel signal acquired from a solid state image pickup device (an image sensor). Otherwise, the present invention is applied to an image pickup system provided with the image pickup apparatus and a displaying device that can display the image signal acquired by the image pickup apparatus with the time-division system.

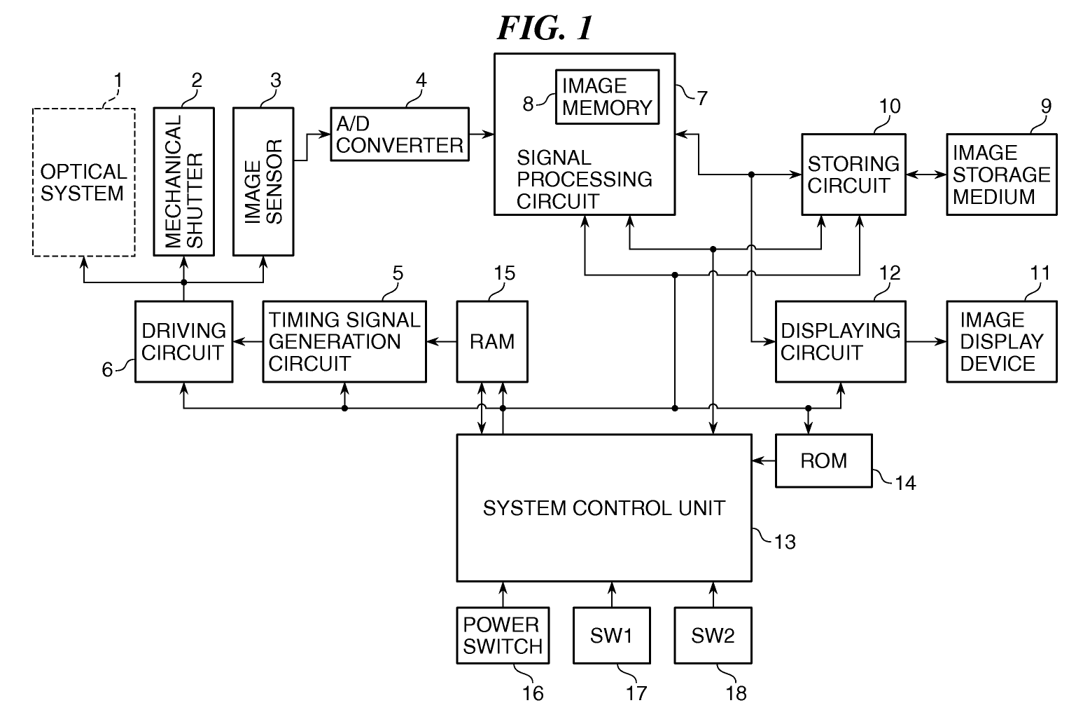

FIG. 1 is a block diagram schematically showing an entire configuration of an image pickup system according to an embodiment of the present invention. Specifically, the image pickup system in FIG. 1 is a digital camera that can shoot a moving image. The image pickup system has an optical system 1, a mechanical shutter 2, an image sensor 3, an A/D converter 4, a timing signal generation circuit 5, and a driving circuit 6.

The optical system 1 comprises optical elements like a lens, a diaphragm, etc. Details of the optical system 1 will be described below. The mechanical shutter 2 can cut off an incident light onto the image sensor 3 to control exposure time of the image sensor 3. The image sensor 3 is provided with a plurality of pixels that generate electric charges by receiving the incident light and that are arranged in two dimensions, and outputs electric signals based on the generated electric charges as analog signals. The details of the image sensor 3 will be described later. The A/D converter 4 converts the analog signals outputted from the image sensor 3 into digital image signals. The timing signal generation circuit 5 generates the signals that operate the image sensor 3 and the A/D converter 4. The driving circuit 6 drives the optical system 1, the mechanical shutter 2, and the image sensor 3.

The image pickup system is further provided with a signal processing circuit 7, an image memory 8, an image storage medium 9, a storing circuit 10, an image display device 11, a displaying circuit 12, a system control unit 13, a nonvolatile memory (ROM) 14, and a volatile memory (RAM) 15.

The signal processing circuit 7 performs signal processes for various corrections required for the acquired image signal. The image memory 8 stores the image data to which the signal process has been applied. The image storage medium 9 is detachable from the image pickup system, and stores image data. The storing circuit 10 stores the image data to which the signal process has been applied to the image storage medium 9. The image display device 11 displays the image data to which the signal process has been applied. The image display device 11 may be built in the image pickup system or may be a separate device such as a display device or a projector that is connected externally. The displaying circuit 12 displays an image on the image display device 11. The system control unit 13 controls the whole image pickup system.

The nonvolatile memory (ROM) 14 stores a program that describes a control method executed by the system control unit 13, control data like parameters and tables that are used when the program is executed, correction data used for various corrections for image signals, etc. The volatile memory (RAM) 15 is used when the system control unit 13 controls the image pickup system, for example, when the program, the control data, and the correction data are transmitted and stored, etc.

The image pickup system is further provided with a power switch 16 that switches a main power of the image pickup system, a switch (SW1) 17 that instructs acquisition of a moving image, and a switch (SW2) 18 that instructs acquisition of a static image. The image pickup system is further provided with a 2D/3D changeover switch (not shown) that changes a mode between a three-dimensional shooting (referred to as a “3D shooting” hereafter) that is a first shooting mode and a two-dimensional shooting (referred to as a “2D shooting” hereafter) that is a second shooting mode.

When the system control unit 13 starts the operation before a shooting operation, i.e., when the power of the image pickup system turns ON, for example, the program needed, the control data, and the correction data are transmitted to the volatile memory 15 from the nonvolatile memory 14, and are stored. Such program and data are used when the system control unit 13 controls the image pickup system. If needed, an additional program and data are transmitted to the volatile memory 15 from the nonvolatile memory 14, or the system control unit 13 reads and uses the data in the nonvolatile memory 14 directly.

Next, the shooting operation will be described. First, the diaphragm and the lens of the optical system 1 are driven according to control signals from the system control unit 13, which forms a subject image of suitable brightness on the image sensor 3. Next, the mechanical shutter 2 is driven to shade the image sensor according to the control signal from the system control unit 13 so as to give necessary exposure time in accordance with the operation of the image sensor 3. It should be noted that the image sensor 3 may be used to keep the necessary exposure time together with the mechanical shutter 2 when the image sensor 3 has a function of an electronic shutter.

The image sensor 3 is driven by a drive pulse based on an operation pulse generated by the timing signal generation circuit 5 that is controlled by the system control unit 13, converts the subject image into an electrical signal by a photoelectric conversion, and outputs it as an analog image signal. The analog image signal outputted from the image sensor 3 is converted into a digital image signal by the A/D converter 4 according to the operation pulse generated by the timing signal generation circuit 5 that is controlled by the system control unit 13.

Next, the signal processing circuit 7 controlled by the system control unit 13 applies various image processes such as derivation (judgment) of various correction values and corrections, a color conversion, a white balance, and a gamma correction, a resolution conversion process, an image data compression process, etc. to the digital image signal. The image memory 8 in the signal processing circuit 7 is used in order to store the digital image signal under signal processing temporarily or to store the image data that is the digital image signal to which the signal process has been applied.

The storing circuit 10 converts the image data to which the signal process has been applied by the signal processing circuit 7 and the image signal stored in the image memory 8 into a data structure (for example, file system data with a hierarchy structure) that is suitable for the image storage medium 9, and stores the converted data into the image storage medium 9. The signal processing circuit 7 applies the resolution conversion process to the image data converted into the digital image signal by the A/D converter 4. And then, the displaying circuit 12 converts the digital image signal into a signal suitable for the image display device 11, and the image display device 11 displays it. The storing circuit 10 outputs information (a type, free space, etc.) about the image storage medium 9 to the system control unit 13 in response to a request from the system control unit 13.

It should be noted that the signal processing circuit 7 may output the digital image signal to the image memory 8 or the storing circuit 10 according to the control signal from the system control unit 13 without applying the signal process. The signal processing circuit 7 may output image information about the digital image signal and image data that is generated during the signal process, and information extracted from the image information to the system control unit 13 according to the request from the system control unit 13. The image information about the digital image signal and the image data includes a spatial frequency of an image, an average value of pixel signals in a designated area, data volume of a compressed image, etc., for example.

Next, a reproducing operation of the shot image will be described. When image data is stored in the image storage medium 9, the storing circuit 10 reads the image data from the image storage medium 9 according to the control signal from the system control unit 13. Then, the signal processing circuit 7 applies an image extension process to the image data according to the control signal from the system control unit 13 when the image data is a compressed image, and stores it to the image memory 8. The signal processing circuit 7 applies the resolution conversion process to the image data stored in the image memory 8. And then, the displaying circuit 12 converts the processed image data into a signal suitable for the image display device 11, and the image display device 11 displays it.

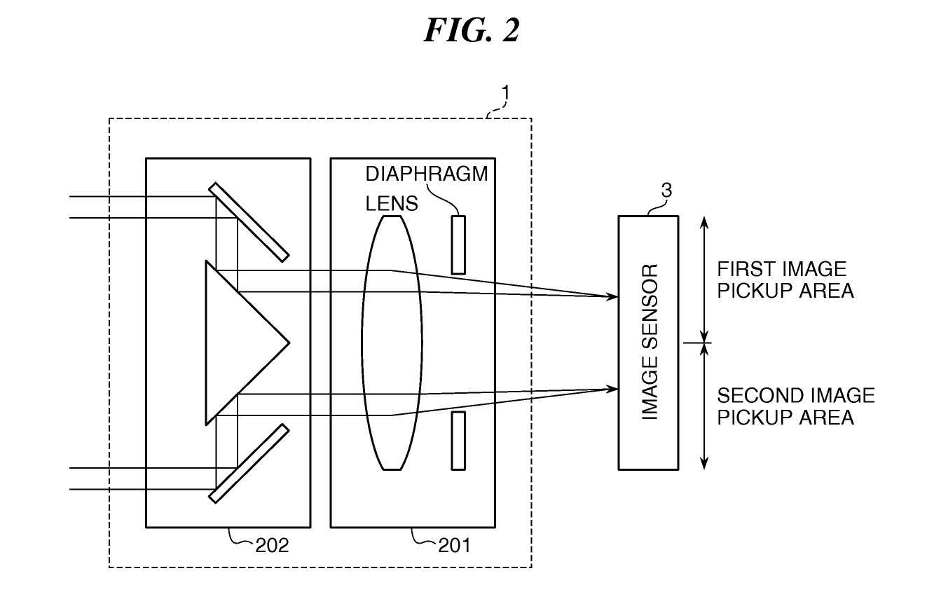

FIG. 2 is a view showing a configuration of the optical system 1 with which the image pickup system in FIG. 1 is equipped. The optical system 1 is provided with a monocular lens unit 201 that has the lens and the diaphragm and forms a subject image on an image pickup surface of the image sensor 3, and a parallax separation device 202 that is attached to the monocular lens unit 201 as an adapter.

The parallax separation device 202 divides the same subject image into a plurality of images (two images of right and left) to which a parallax is given by a mirror etc. It should be noted that the parallax separation device 202 is detachable and is attached at the time of 3D shooting and is removed at the time of 2D shooting.

The image sensor 3 is a CMOS image sensor of a single plate. A first image to which first parallax is given by the optical system 1 is formed within one half area in the image pickup surface of the image sensor 3, and a second image to which second parallax is given by the optical system 1 is formed within the other half area in the image pickup surface of the image sensor 3. The area where the first image is formed is called a “first image pickup area”, and the area where the second image is formed is called a “second image pickup area”. Thus, the optical system 1 forms the images of the same subject on the first image pickup area and the second image pickup area image through different optical axes, respectively. In the 3D shooting, the image outputted from the first image pickup area shall be a left eye image and the image outputted from the second image pickup area shall be a right eye image.

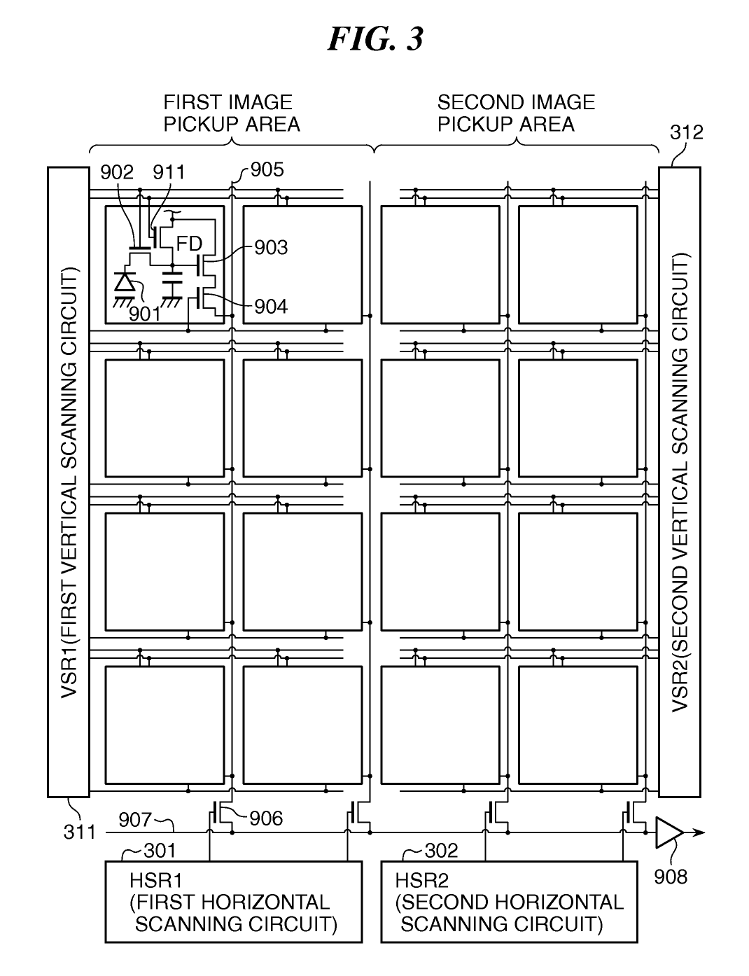

FIG. 3 is an equivalent circuit schematic of a CMOS image sensor used as the image sensor 3 with which the image pickup system is provided. Each pixel of the CMOS image sensor is provided with a photodiode 901, a transfer gate 902, an amplification MOS 903, a selector gate 904, and a pixel reset gate 911.

Pixels are connected to a vertical output line 905 for every vertical column in FIG. 3. The vertical output line 905 is connected to a horizontal output line 907 via a horizontal scanning switch 906. The horizontal output line 907 is connected to an output amplifier 908.

In the image sensor 3 in FIG. 3, transmission lines of control pulses for the first image pickup area are separated from transmission lines of control pulses for the second image pickup area. That is, drive pulses for the first image pickup area are given from a first vertical scanning circuit (VSR1) 311 and a first horizontal scanning circuit (HSR1) 301. Drive pulses for the second image pickup area are given from a second vertical scanning circuit (VSR2) 312 and a second horizontal scanning circuit (HSR2) 302. The first and second vertical scanning circuits 311 and 312 sequentially output transfer pulses, row select pulses, and control pulses for controlling the gates of the pixel section, such as pixel reset pulses for controlling the pixel reset gate 911. The first and second horizontal scanning circuits 301 and 302 sequentially output horizontal scanning pulses that control opening and closing of the horizontal scanning switch 906. The pixel reset gate 911 controls accumulation and reset of electric charge of the photodiode 901 and an FD section.

The photodiode 901 generates an electric charge in response to a light signal. The transfer gate 902 transfers the electric charge generated by the photodiode 901 to the FD section according to the transfer pulses from the first and second vertical scanning circuits 311 and 312. The amplification MOS 903 converts the electric charge transferred to the FD section into a voltage signal, and amplifies it. The selector gate 904 selects pixels according to the row select pulses from the first and second vertical scanning circuits 311 and 312, and controls the pixel sections to output the voltage signals of the selected pixels to the vertical output line 905. The vertical output line 905 transfers the voltage signals outputted from the pixels to the horizontal output line 907.

The horizontal scanning switch 906 controls transfer of the voltage signals from the vertical output line 905 to the horizontal output line 907 according to column selection pulses from the first and second horizontal scanning circuits 301 and 302. The horizontal output line 907 transfers the voltage signals transmitted via the horizontal scanning switch 906 from the vertical output line 905 to the output amplifier 908. The output amplifier 908 amplifies the voltage signals outputted via the horizontal output line 907, and outputs them.

Next, a reading method of the pixel signals by the CMOS image sensor in FIG. 3 will be described. Since the CMOS image sensor shares the vertical output line 905 of one system among the pixels arranged on the same column, a signal of only one pixel among the pixels that share the same vertical output line 905 can be read at a time. Therefore, the pixel signals are serially read from the pixel sections of the CMOS image sensor to the vertical output line 905 for every pixel row. In the same manner, the horizontal output line 907 of one system is shared among the pixel rows. Therefore, only the signal for 1 pixel equivalent to one column in the pixel row which is sharing the same horizontal output line 907 can be read to the same timing. Therefore, the pixel signals are serially read from the vertical output line 905 to the horizontal output line 907 of the CMOS image sensor for every pixel column.

First, the electric charges of the photodiode 901 and the FD section are erased to be a reset state by opening the transfer gate 902 while opening the pixel reset gate 911. Then, the control of accumulation and reading of the signals starts for a predetermined pixel row. First, the transfer gate 902 is closed and the photodiode 901 is exposed. Accordingly, the photodiode 901 generates an electric charge corresponding to the irradiated light amount. Next, the reset gate 911 is closed to release the reset state of the FD section, and the transfer gate 902 is opened to transfer the electric charges for one row from the photodiodes 901 to the FD sections at a time.

Next, after closing the transfer gate 902 and completing transfer of the electric charges to the FD section, the row selector gate 904 is opened and the electric charge held in the FD section is outputted to the vertical output line 905. At this time, since the signal passes through the amplification amplifier 903, the electric charge held by the FD section is converted into a voltage signal, is amplified, and is outputted to the vertical output line 905. In this condition, when the horizontal scanning switches 906 connected to the same horizontal output line 907 from which the signals are read first are sequentially opened and closed for every column, the voltage signals of the vertical output lines 905 corresponding to one row are transferred to the horizontal output line 907.

After the voltage signals transferred to the horizontal output line 907 are outputted via the output amplifier 908, the horizontal scanning switches 906 from which the signals are read next are sequentially opened and closed for every column, the voltage signals of the vertical output lines 905 corresponding to one row are transferred to the horizontal output line 907. The operation is performed one by one to all the rows from which the signals are read out. The above operations are repeated at predetermined time intervals corresponding to the required number of rows to read the pixel signals of all the pixels.

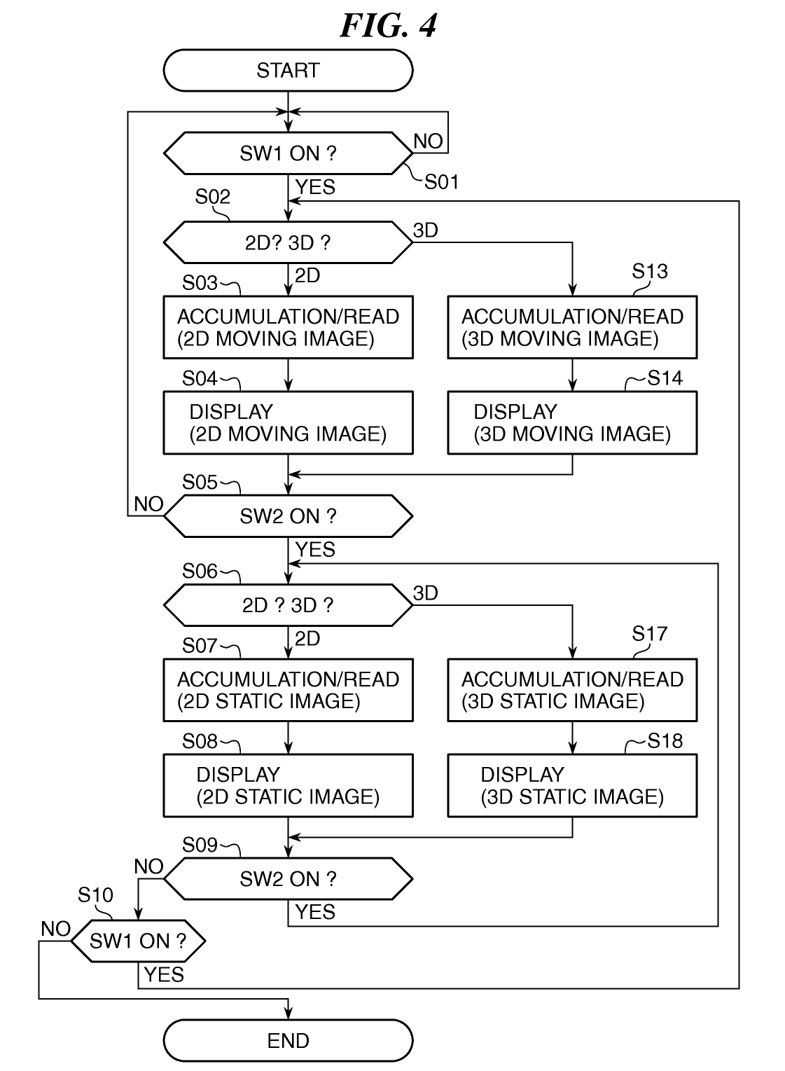

The signal reading operation from the image sensor 3 will be described together with the shooting operation of the image pickup system, etc. FIG. 4 is a flowchart showing an image pickup operation and a displaying operation of the image pickup system. First, the system control unit 13 determines whether the switch (SW1) 17 that instructs to pickup the moving image is turned ON (step S01). When the switch (SW1) 17 is OFF (“NO” in the step S01), the determination in the step S01 is repeated until the switch (SW1) 17 is turned ON. When the switch SW1 is turned ON (“YES” in the step S01), the process proceeds to step S02.

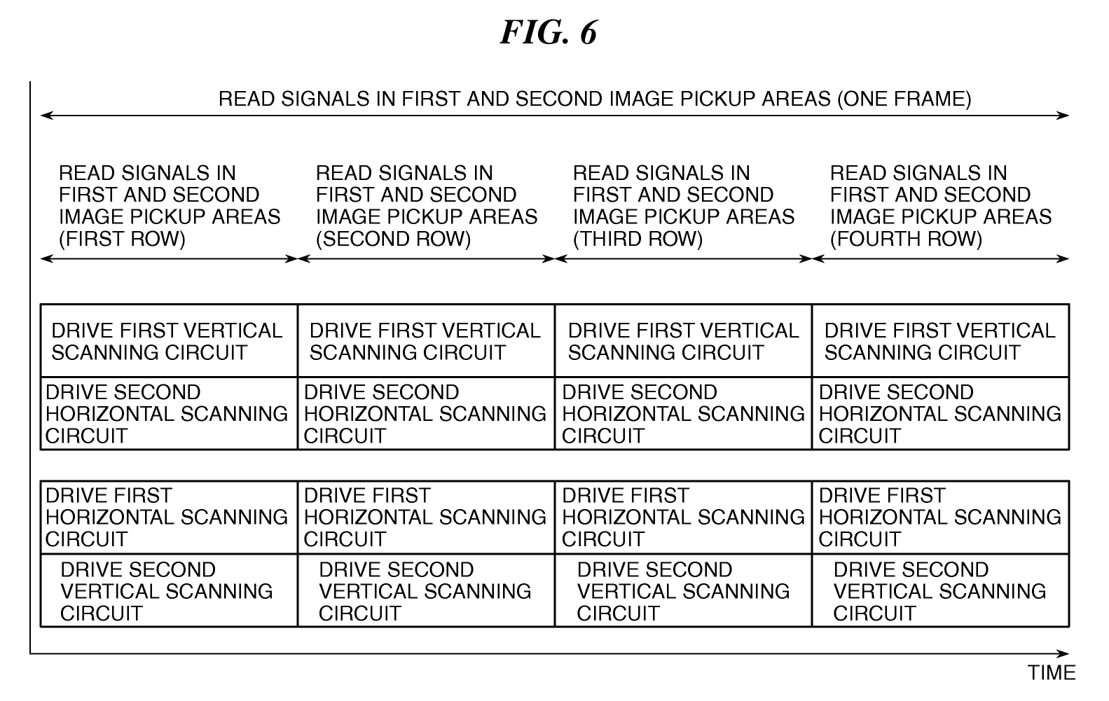

In the step S02, the system control unit 13 detects the condition of the 2D/3D changeover switch (not shown in FIG. 1) in order to determine whether the moving image will be shot as the 2D shooting or the 3D shooting. In the 2D shooting, the process proceeds to step S03, and in the 3D shooting, the process proceeds to step S13. In the step S03, the system control unit 13 accumulates signals in the image sensor 3 and reads the signals using a 2D reading drive pattern, which will be described with reference to FIG. 6 as a first reading mode corresponding to the 2D shooting, and then, proceeds with the process to step S04. In the step S04, the system control unit 13 displays the signals read in the step S03 on the image display device 11 as the 2D image.

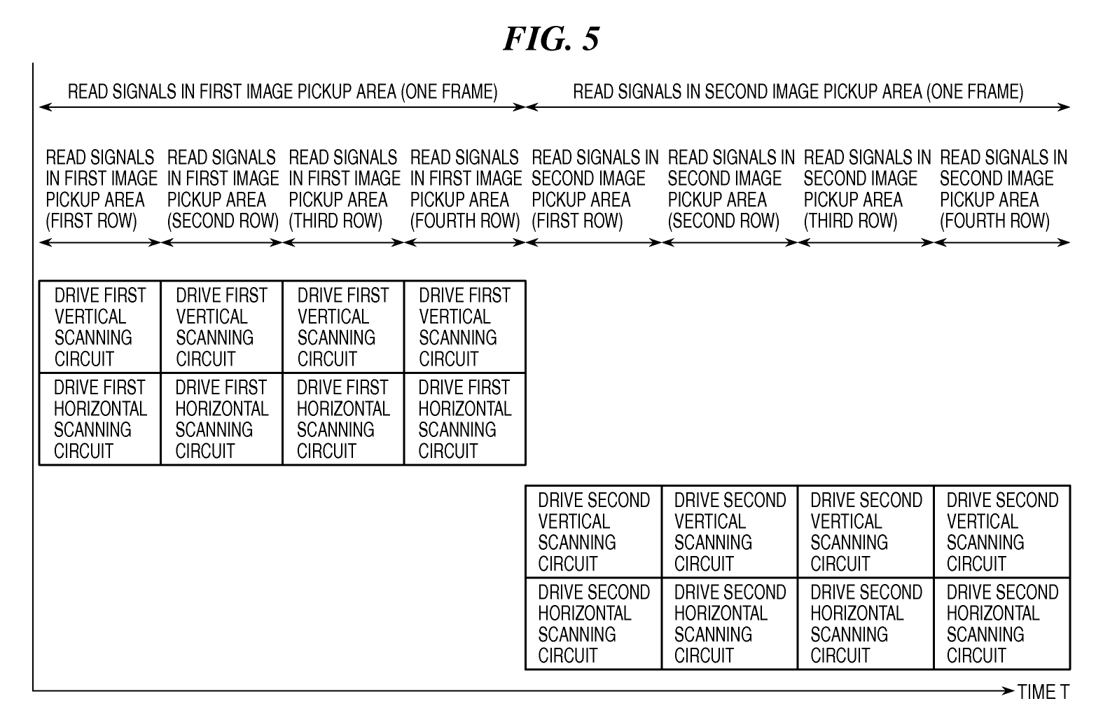

On the other hand, in the step S13, the system control unit 13 accumulates signals in the image sensor 3 and reads the signals using a 3D reading drive pattern, which will be described with reference to FIG. 5 as a second reading mode corresponding to the 3D shooting, and then, proceeds with the process to step S14. In the step S14, the system control unit 13 displays the signals read in the step S13 on the image display device 11 as the 3D image.

After the processes in the steps S04 and S14, the process proceeds to step S05. In the step S05, the system control unit 13 determines whether the switch (SW2) 18 that instructs to pickup the static image is turned ON. When the switch (SW2) 18 is not turned ON (“NO” in the step S05), the system control unit 13 determines that the static image is not shot, and returns the process to the step S01. When the switch (SW2) 18 is turned ON (“YES” in the step S05), the system control unit 13 proceeds with the process to step S06 in order to start shooting a static image.

In the step S06, the system control unit 13 detects the condition of the 2D/3D changeover switch in order to determine whether the static image will be shot as the 2D shooting or the 3D shooting. In the 2D shooting, the process proceeds to step S07, and in the 3D shooting, the process proceeds to step S17.

In the step S07, the system control unit 13 accumulates signals in the image sensor 3 and reads the signals using the 2D reading drive pattern, which will be described with reference to FIG. 6, and then, proceeds with the process to step S08. In the step S08, the system control unit 13 displays the signals read in the step S07 on the image display device 11 as the 2D image.

On the other hand, in the step S17, the system control unit 13 accumulates signals in the image sensor 3 and reads the signals using the 3D reading drive pattern, which will be described with reference to FIG. 5, and then, proceeds with the process to step S18. In the step S18, the system control unit 13 displays the signals read in the step S17 on the image display device 11 as the 3D image.

After the processes in the steps S08 and S18, the process proceeds to step S09. In the step S09, the system control unit 13 determines whether the switch (SW2) 18 that instructs to pickup the static image is turned ON. When the switch (SW2) 18 is not turned ON (“NO” in the step S09), the system control unit 13 determines that the static image has been picked up, and proceeds with the process to step S10. When the switch (SW2) 18 is turned ON (“YES” in the step S09), the system control unit returns the process to the step S06 in order to pickup a static image again.

In the step S10, the system control unit 13 determines whether the switch (SW1) 17 that instructs to pickup the moving image is turned ON. When the switch (SW1) 17 is turned ON (“YES” in the step S10), the system control unit 13 returns the process to the step S02 in order to pickup the moving image. On the other hand, when the switch (SW1) 17 is not turned ON (“NO” in the step S10), the system control unit 13 finishes a series of the image pickup operation.

Although the determinations in the steps S02 and S06 are based on the condition of the 2D/3D changeover switch in the above-mentioned embodiment, the present invention is not limited to the embodiment. For example, when the image pickup apparatus is connected to a separate display device, the image pickup apparatus may automatically acquire the display method of the display device and may determine whether the display method is the two-dimensional display (2D display) or the three-dimensional display (3D display). In this case, a wired or wireless communication method (not shown) may be used to acquire the display method of the display device, for example.

Further, the image pickup apparatus may automatically set the shooting mode by determining whether the parallax separation device 202 is attached. In such a case, when the parallax separation device 202 is attached, the 3D shooting is set, and when the parallax separation device 202 is not attached, the 2D shooting is set. After determining the 3D shooting in the steps S02 and S06, the reading drive pattern may be determined based on the determination of whether the 3D display system of the image display device 11 is the time-division system or not.

The reading drive pattern may be determined according to the display method selected by a user in advance. For example, when the image display device displays an image with the time-division system, the drive pattern shown in FIG. 5 is selected. On the other hand, when the image display device displays an image with a system other than the time-division system (for example, a parallax separation system represented by a lenticular system and the parallax barrier system), the drive pattern shown in FIG. 6 is selected like the 2D image.

When a predetermined image is displayed on the image display device 11 that is connected externally in the steps S04, S08, S14, and S18, the image pickup apparatus automatically determines the display method of the image display device 11 by the communication, and reads the signals in the drive pattern that is suitable for the display method of the image display device 11. It should be noted that a user can set the drive pattern in place of the automatic setting.

FIG. 5 is a view showing the 3D signal reading pattern used in the steps S13 and S17 in the flowchart in FIG. 4 that shows the image pickup operation. In this drive pattern, the drive pulses from the first horizontal scanning circuit 301 and the first vertical scanning circuit 311 are outputted in synchronization with each other to read the signals from pixels in four rows that correspond to one frame in the first image pickup area. Then, the drive pulses from the second vertical scanning circuit 312 and the second horizontal scanning circuit 302 are outputted in synchronization with each other to read the signals from pixels in four rows that correspond to one frame in the second image pickup area. By repeating these patterns alternately, the signals equivalent to one frame of the first image pickup area and the signals equivalent to one frame of the second image pickup area are read alternately.

In the 3D shooting, since the signals equivalent to the left eye image are outputted at the time when the scan for one frame of the first image pickup area is completed, the time lag between the shooting and the displaying is shortened when the 3D image is displayed with the time-division system as compared with the conventional case where the left and right eye images are displayed after the signals of all the pixels have been scanned.

FIG. 6 is a view showing the 2D signal reading pattern used in the steps S03 and S07 in the flowchart in FIG. 4 that shows the image pickup operation. In this drive pattern, the signals of the pixels on the same row across the first and second image pickup areas are read by a series.

Specifically, the vertical drive pulses are outputted from the first vertical scanning circuit 311 and the second vertical scanning circuit 312 simultaneously. First, the horizontal drive pulses are outputted from the first horizontal scanning circuit 301 in synchronization with the vertical drive pulses to read the signals of the two pixels of one row in the first image pickup area. Continuously, the horizontal drive pulses are outputted from the second horizontal scanning circuit 302 in synchronization with the vertical drive pulses to read the signals of the two pixels of the same row in the second image pickup area. These operations are repeated for every row to pickup the signals of all the pixels as one frame.

Next, the reason why the different signal reading drive pattern is used according to the determination result of the 2D shooting or the 3D shooting in the steps S02 and S06 in the flowchart in FIG. 4 will be described.

The 2D image is generated as a single image using the pixel signal acquired from all the areas of the image sensor 3. If the signals are read with the drive pattern in FIG. 5, the image signals acquired from the first image pickup area and the image signals acquired from the second image pickup area are read as two images divided into right and left. Therefore, it will be necessary to connect the boundary of the two images after reading. This complicates the image processing circuit (for example, the signal processing circuit 7) in connection with image composition, or increases circuit structure.

In order to prevent such a trouble, the reading drive pattern in FIG. 6 is used in the steps S02 and S06 according to the determination result of the 2D shooting or the 3D shooting. The reading drive pattern in FIG. 6 is suitable for the 2D shooting because the signals are not divided into two image pickup areas. On the other hand, when reproducing the 3D image with the time-division system, the drive pattern in FIG. 5 is used for shooting. It should be noted that the drive pattern in the FIG. 6 may be used when the 3D image will be displayed with the parallax separation system.

As mentioned above, when the signal reading drive pattern in FIG. 5 is used, the time lag between reading of the pixel signal from the image sensor 3 and displaying of the image signal generated from the pixel signal can be shortened. The pixel signals can be read in the suitable orders for the 2D image and the 3D image, respectively, which can prevent the image processing circuit from complicating and can prevent the circuit structure from becoming large.

In the above-mentioned embodiment, the first and second horizontal scanning circuits 301 and 302 are used as shown in FIG. 3. On the other hand, these may be combined into a single horizontal scanning circuit. In the later case, the horizontal scanning circuit outputs the drive pulses corresponding to the pixels from the top column to the end column in the first image pickup area when the 3D image is read. By repeating this operation by the number of rows, the signals for one frame in the first image pickup area is read. Next, the horizontal scanning circuit outputs the drive pulses corresponding to the pixels from the top column to the end column in the second image pickup area. By repeating this operation by the number of rows, the signals for one frame in the second image pickup area is read.

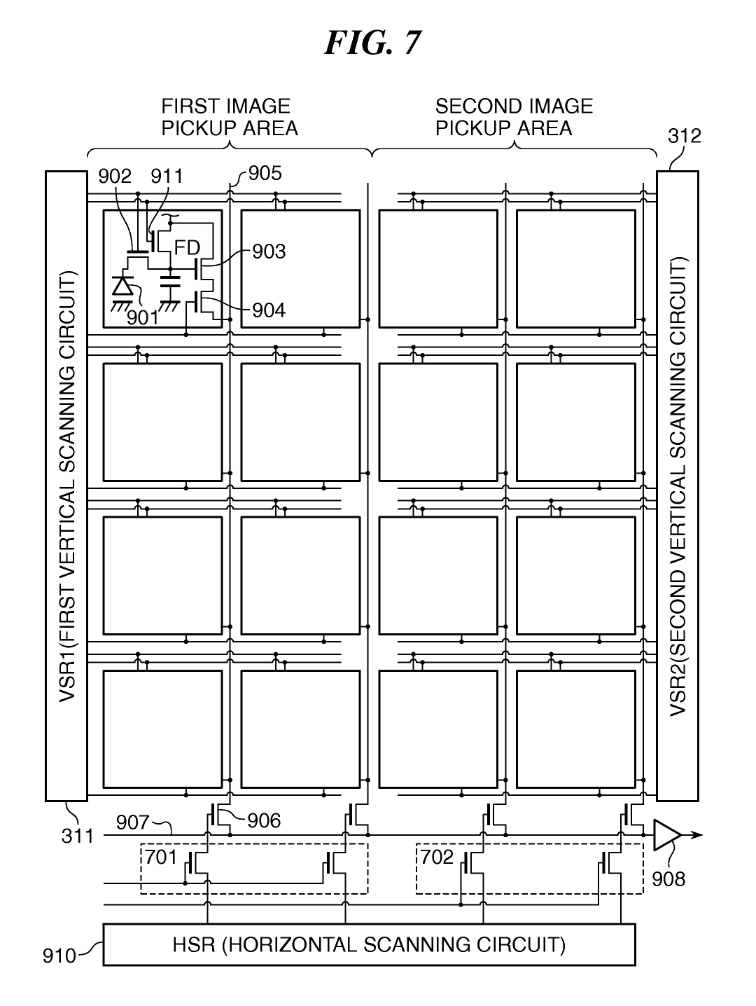

Alternatively, opening and closing of the gates of the horizontal scanning switches 906 for the first image pickup area and that for the second image pickup area may be controlled independently. FIG. 7 is an equivalent circuit schematic of a modification of the CMOS image sensor shown in FIG. 3.

In the configuration in FIG. 7, a common horizontal scanning circuit 910 is arranged for the first image pickup area and the second image pickup area. A first area selection switch 701 is arranged between the horizontal scanning circuit 910 and the gates of the horizontal scanning switches 906 for the first image pickup area. A second area selection switch 702 is arranged between the horizontal scanning circuit 910 and the gates of the horizontal scanning switches 906 for the second image pickup area. The first and second area selection switches 701 and 702 can be controlled independently.

When the signals in the first image pickup area are read from the CMOS image sensor in FIG. 7 using the signal reading drive pattern in FIG. 5, the first area selection switch 701 is turned ON and the second area selection switch 702 is turned OFF. When the signals in the second image pickup area are read, the second area selection switch 702 is turned ON and the first area selection switch 701 is turned OFF. When the signals are read using the signal reading drive pattern in FIG. 6, both the first and second area selection switches 701 and 702 are turned ON so that the horizontal scan for the entire area becomes effective.

Although the embodiments of the invention have been described, the present invention is not limited to the above-mentioned embodiments, the present invention includes various modifications as long as the concept of the invention is not deviated. The above mentioned embodiments merely show the examples of the present invention. The embodiments can be combined.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-217095, filed on Sep. 28, 2010, which is hereby incorporated by reference herein in its entirety.

What is claimed is:

1. An image pickup system comprising:
a solid state image pickup device configured to have pixels that receive incident lights and generate electric charges, the pixels being arranged in two dimensions and being divided into image pickup areas;
a reading unit configured to read signals from the image pickup areas of said solid state image pickup device;
a mode setting unit configured to set either of a first shooting mode and a second shooting mode that is different from the first shooting mode; and
a control unit configured to control said reading unit to read signals from all the image pickup areas as a single frame when said mode setting unit sets the first shooting mode, and to read the signals from the image pickup areas as different frames, respectively, when said mode setting unit sets the second shooting mode.

2. The image pickup system according to claim 1, wherein the first shooting mode is a two-dimensional shooting mode and the second shooting mode is a three-dimensional shooting mode.

3. The image pickup system according to claim 2, further comprising an optical system configured to take in lights from a subject and forms a subject image onto said solid state image pickup device, and wherein said optical system forms images of the same subject through different optical axes onto the image pickup areas, respectively, in the second shooting mode.

4. An image pickup system comprising:
a solid state image pickup device configured to have pixels that receive incident lights and generate electric charges, the pixels being arranged in two dimensions and being divided into image pickup areas;
a reading unit configured to read signals from the image pickup areas;
a display unit configured to display an image based on the signals read by said reading unit; and
a control unit configured to control said reading unit to read signals from all the image pickup areas as a single frame when a display method of said display unit is a two-dimensional display, and to read the signals from the image pickup areas as different frames, respectively, when the display method of said display unit is a three-dimensional display.

5. An image pickup system comprising:
a solid state image pickup device configured to have pixels that receive incident lights and generate electric charges, the pixels being arranged in two dimensions and being divided into image pickup areas;
a reading unit configured to read signals from the image pickup areas;
a display unit configured to display an image based on the signals read by said reading unit; and
a control unit configured to control said reading unit to read signals from all the image pickup areas as a single frame when a display method of said display unit is other than a time-division system, and to read the signals from the image pickup areas as different frames, respectively, when the display method of said display unit is the time-division system.
